(19) United States
(12) Patent Application Publication
(10) Pub. No.: US 2017/0298563 A1
(43) Pub. Date: Oct. 19, 2017

(54) Laundry Additive Dispenser

(71) Applicant: General Electric Company, Schenectady, NY (US)

(72) Inventors: John Joseph Roetker, Louisville, KY (US); Liam Doherty, Gainesville, FL (US)

(21) Appl. No.: 15/132,333

(22) Filed: Apr. 19, 2016

(51) Int. Cl. D06F 39/02; D06F 21/08; D06F 33/02; G06F 3/048

(52) U.S. Cl. CPC D06F 39/028; G06F 3/048; D06F 21/08; D06F 33/02

(57) ABSTRACT

A washing machine appliance having an improved additive dispenser is provided. The chamber geometry and water flow pattern of the additive dispenser provide complete delivery of wash liquid, even when using powdered detergent during low water volume dispense cycles. The water flows past the siphon inlet to clear the siphon path, dissolve and entrain wash additive, and clear the chamber floor upon delivery of the wash liquid.

### FIELD OF THE INVENTION

The present subject matter relates generally to washing machine appliances and more particularly to additive dispensers for washing machine appliances.

### BACKGROUND OF THE INVENTION

Washing machine appliances generally include a tub for containing water or wash liquid, e.g., water and detergent, bleach, and/or other wash additives. A basket is rotatably mounted within the tub and defines a wash chamber for receipt of articles for washing. During normal operation of such washing machine appliances, the wash liquid is directed into the tub and onto articles within the wash chamber of the basket. The basket or an agitation element can rotate at various speeds to agitate articles within the wash chamber, to wring wash fluid from articles within the wash chamber, etc.

During operation of certain washing machine appliances, a volume of wash liquid is directed into the tub in order to wash and/or rinse articles within the wash chamber. One or more fluid additives may be added to the wash liquid to enhance the cleaning or other properties of the wash liquid. The fluid additives may be in powder or concentrated liquid form, and are generally added to a dispenser box of the washing machine appliance by, e.g., a user of the washing machine appliance. The dispenser box may contain various chambers for containing different additives, e.g., wash detergent and softener. Water may be directed into the chambers of the dispenser box through a plurality of water inlet valves to mix with the additives and the resulting wash liquid is then dispensed into the wash chamber.

A typical dispenser box includes a bottom surface that slopes toward a siphon having a siphon inlet close to the bottom surface. Water is added to the dispenser box to mix with the wash additive and form a wash liquid. After the wash liquid has breached the top of the siphon, wash liquid flows through the siphon into the tub until the level of the wash liquid drops below the siphon inlet. In addition, such a dispenser box may also include an overflow weir for delivery of excess wash liquid into the wash chamber.

However, conventional dispenser boxes have bottom surfaces that have a single, uniformly sloped surface. Thus, wash additive tends to collect around the siphon inlet. In addition, water is typically added to the dispenser box by directing it downward over the entire chamber, i.e., a “rainfall” or “shower” flow. Alternatively, these dispenser boxes spray water directly at the detergent to flood the chamber. Particularly when powdered detergent is used, conventional dispenser boxes and methods of adding water to the dispenser box result in powdered detergent clogging the siphon inlet. More specifically, the powdered detergent is forced to the siphon inlet before sufficient mixing with water may occur, resulting in a partial slurry that has low viscosity, clogs the siphon inlet, and terminates the siphon effect. This results in improper mixing of the water and detergent and prevents complete delivery of wash liquid, particularly when late cycle or low water volume dispense cycles are selected.

Accordingly, an additive dispenser for a washing machine appliance that improves the delivery of detergent is desirable. More particularly, an additive dispenser that improves complete delivery of powdered detergent during low water volume dispense cycles would be particularly beneficial.

### BRIEF DESCRIPTION OF THE INVENTION

The present subject matter provides a washing machine appliance having an improved additive dispenser having a chamber geometry and water flow pattern that provides complete delivery of wash liquid, even when using powdered detergent during low water volume dispense cycles. The water flows past the siphon inlet to clear the siphon path, dissolve and entrain wash additive, and clear the chamber floor upon delivery of the wash liquid. Additional aspects and advantages of the invention will be set forth in part in the following description, or may be apparent from the description, or may be learned through practice of the invention.

In one exemplary embodiment, a washing machine appliance defining a vertical, a lateral, and a transverse direction is provided. The washing machine appliance includes a cabinet; a tub positioned within the cabinet; and a wash basket rotatably mounted within the tub, the wash basket defining a wash chamber for receiving articles for washing. The washing machine appliance further includes an additive dispenser positioned within the cabinet and configured to provide wash liquid to the tub. The additive dispenser includes a lower portion including a bottom surface defining a siphon sump and a plateau that includes a receiving surface, the siphon sump positioned below the plateau. An upper portion is joined with the lower portion to form a dispenser chamber, the upper portion defining an opening configured to receive a wash additive, the opening being positioned directly over the receiving surface. A siphon having a siphon inlet is positioned in the siphon sump and a water delivery nozzle is mounted to the upper portion and configured to provide a flow of water to the dispenser chamber, the flow of water being directed adjacent to and past the receiving surface toward the siphon sump.

In another exemplary embodiment, an additive dispenser for providing wash liquid to a tub of a washing machine appliance is provided. The additive dispenser includes a lower portion including a bottom surface defining an overflow weir, a plateau that includes a receiving surface, and a siphon sump, the siphon sump positioned below the plateau. An upper portion is joined with the lower portion to form a dispenser chamber, the upper portion defining an opening configured to receive a wash additive, the opening being positioned directly over the receiving surface. A siphon having a siphon inlet is positioned in the siphon sump adjacent the overflow weir and a water delivery nozzle is mounted to the upper portion and configured to provide a flow of water to the dispenser chamber, the flow of water being directed around the overflow weir on a side opposite the siphon.

In still another exemplary embodiment, a washing machine appliance defining a vertical, a lateral, and a transverse direction is provided. The washing machine appliance includes a cabinet; a tub positioned within the cabinet; and a wash basket rotatably mounted within the tub, the wash basket defining a wash chamber for receiving articles for washing. An additive dispenser is positioned within the cabinet and configured to provide wash liquid to the tub. The additive dispenser includes a lower portion and an upper portion joined with the lower portion to form a dispenser chamber. A water delivery nozzle is mounted to the upper portion proximate a first end of the dispenser chamber, the water delivery nozzle being configured to provide a flow of water to the dispenser chamber. The additive dispenser further includes a siphon sump proximate a second end of the dispenser chamber and including a siphon and a siphon inlet; and a sloping surface defining a receiving surface, the siphon sump positioned below the sloping surface. The flow of water is directed from the first end toward the second end directly toward the siphon sump, such that the flow of water passes adjacent to the receiving surface, and wherein the second end of the dispenser chamber is curved to direct the flow of water past the siphon inlet and back up onto the sloping surface.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a washing machine appliance according to an exemplary embodiment of the present subject matter with a door of the exemplary washing machine appliance shown in a closed position.

FIG. 2 provides a perspective view of the exemplary washing machine appliance of FIG. 1 with the door of the exemplary washing machine appliance shown in an open position.

FIG. 3 provides a top, perspective view of a lower portion of an additive dispenser according an exemplary embodiment of the present subject matter, with an upper portion removed for clarity.

FIG. 4 provides a bottom, perspective view of the upper portion of the exemplary additive dispenser of FIG. 3.

FIG. 5 provides a top view of the exemplary additive dispenser of FIG. 3.

FIG. 6 provides a top view of the exemplary additive dispenser of FIG. 3, with part of the upper portion removed for clarity.

FIG. 7 provides a top view of the lower portion of the exemplary additive dispenser of FIG. 3, with part of the upper portion removed for clarity and the flow path of water indicated by arrows.

FIG. 8 provides a top view of the lower portion of the exemplary additive dispenser of FIG. 3, with part of the upper portion removed for clarity and the flow path of water indicated by arrows.

FIG. 9 provides a cross sectional view of the exemplary additive dispenser of FIG. 3, taken along Line 9-9 of FIG. 6.

FIG. 10 provides a cross sectional view of the exemplary additive dispenser of FIG. 3, taken along Line 10-10 of FIG. 6.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

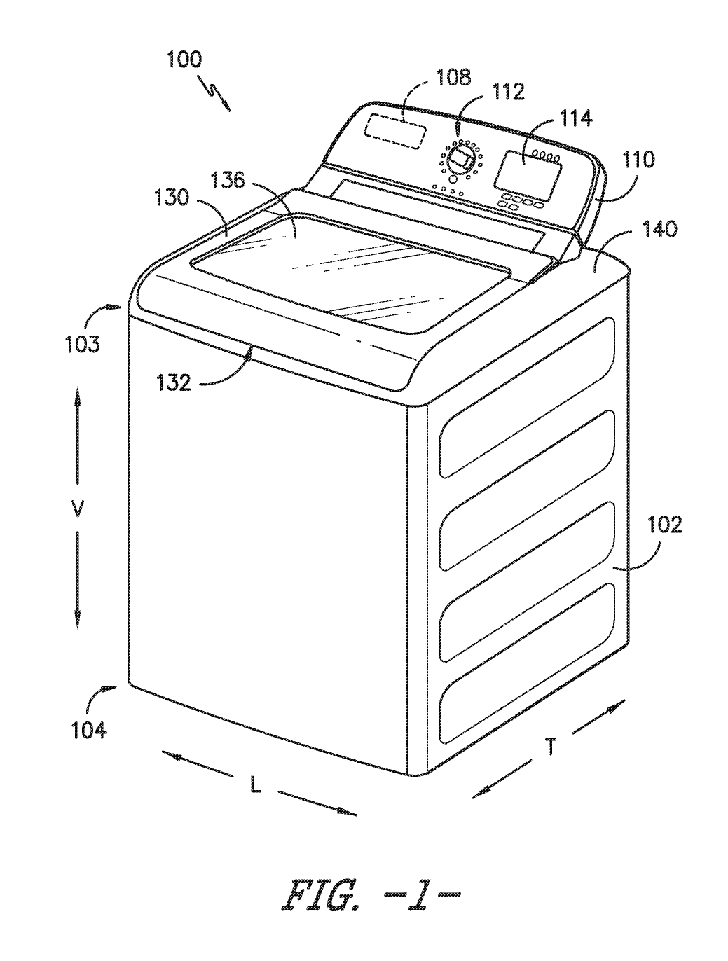

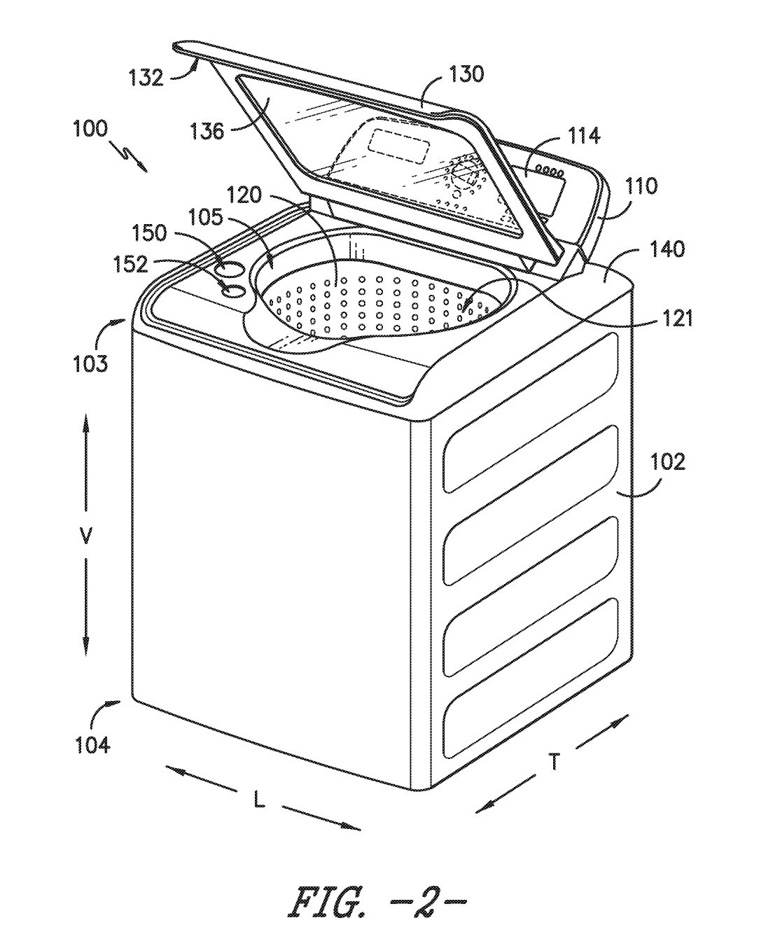

FIGS. 1 and 2 illustrate an exemplary embodiment of a vertical axis washing machine appliance 100. In FIG. 1, a lid or door 130 is shown in a closed position. In FIG. 2, door 130 is shown in an open position. Washing machine appliance 100 generally defines a vertical direction V, a lateral direction L, and a transverse direction T, each of which is mutually perpendicular, such that an orthogonal coordinate system is generally defined.

While described in the context of a specific embodiment of vertical axis washing machine appliance 100, using the teachings disclosed herein it will be understood that vertical axis washing machine appliance 100 is provided by way of example only. Other washing machine appliances having different configurations, different appearances, and/or different features may also be utilized with the present subject matter as well, e.g., horizontal axis washing machines.

Washing machine appliance 100 has a cabinet 102 that extends between a top portion 103 and a bottom portion 104 along the vertical direction V. A wash basket 120 (FIG. 2) is rotatably mounted within cabinet 102. A motor (not shown) is in mechanical communication with wash basket 120 to selectively rotate wash basket 120 (e.g., during an agitation or a rinse cycle of washing machine appliance 100). Wash basket 120 is received within a wash tub or wash chamber 121 (FIG. 2) and is configured for receipt of articles for washing. The wash tub 121 holds wash and rinse fluids for agitation in wash basket 120 within wash tub 121. An agitator or impeller (not shown) extends into wash basket 120 and is also in mechanical communication with the motor. The impeller assists agitation of articles disposed within wash basket 120 during operation of washing machine appliance 100.

Cabinet 102 of washing machine appliance 100 has a top panel 140. Top panel 140 defines an opening 105 (FIG. 2) that permits user access to wash basket 120 of wash tub 121. Door 130, rotatably mounted to top panel 140, permits selective access to opening 105; in particular, door 130 selectively rotates between the closed position shown in FIG. 1 and the open position shown in FIG. 2. In the closed position, door 130 inhibits access to wash basket 120. Conversely, in the open position, a user can access wash basket 120. A window 136 in door 130 permits viewing of wash basket 120 when door 130 is in the closed position, e.g., during operation of washing machine appliance 100. Door 130 also includes a handle 132 that, e.g., a user may pull and/or lift when opening and closing door 130. Further, although door 130 is illustrated as mounted to top panel 140, alternatively, door 130 may be mounted to cabinet 102 or any other suitable support.

A control panel 110 with at least one input selector 112 (FIG. 1) extends from top panel 140. Control panel 110 and input selector 112 collectively form a user interface input for operator selection of machine cycles and features. A display 114 of control panel 110 indicates selected features, operation mode, a countdown timer, and/or other items of interest to appliance users regarding operation.

Operation of washing machine appliance 100 is controlled by a controller or processing device 108 (FIG. 1) that is operatively coupled to control panel 110 for user manipulation to select washing machine cycles and features. In response to user manipulation of control panel 110, controller 108 operates the various components of washing machine appliance 100 to execute selected machine cycles and features.

Controller 108 may include a memory and microprocessor, such as a general or special purpose microprocessor operable to execute programming instructions or micro-control code associated with a cleaning cycle. The memory may represent random access memory such as DRAM, or read only memory such as ROM or FLASH. In one embodiment, the processor executes programming instructions stored in memory. The memory may be a separate component from the processor or may be included onboard within the processor. Alternatively, controller 100 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software. Control panel 110 and other components of washing machine appliance 100 may be in communication with controller 108 via one or more signal lines or shared communication busses.

During operation of washing machine appliance 100, laundry items are loaded into wash basket 120 through opening 105, and washing operation is initiated through operator manipulation of input selectors 112. Wash additives may be added to washing machine appliance 100 to assist in the cleaning process. In this regard, top panel 140 may define one or more apertures configured for receiving wash additives when door 130 is rotated to the open position. For example, as shown in FIG. 2, a first aperture 150 may be configured to receive pretreating additive, bleach, or powdered detergent for late wash cycles. A second aperture 152 may be configured to receive detergent for the primary wash cycle. Each aperture 150, 152 may direct wash additives to a separate additive dispenser or dispensing chamber. By contrast, the wash additives may be directed to a single dispensing chamber separated by a partition, as is known in the art. Although two apertures 150, 152 are illustrated, one skilled in the art will appreciate that one or more than two apertures may be used and may be configured to receive any particular type of wash additive depending on the particular application.

As will be described in detail below, wash additive that is added through first aperture 150 may be received in an additive dispenser 200. Water may be added to additive dispenser 200 to create a wash liquid that may be dispensed into wash basket 120 along with additional water, detergent, and/or other powdered or fluid additives. One or more valves can be controlled by washing machine appliance 100 to provide for filling wash basket 120 to the appropriate level for the amount of articles being washed and/or rinsed. By way of example for a wash mode, once wash basket 120 is properly filled with fluid, the contents of wash basket 120 can be agitated (e.g., with an impeller as discussed previously) for washing of laundry items in wash basket 120.

After the agitation phase of the wash cycle is completed, wash basket 120 can be drained. Laundry articles can then be rinsed by again adding fluid to wash basket 120 depending on the specifics of the cleaning cycle selected by a user. The impeller may again provide agitation within wash basket 120. One or more spin cycles also may be used. In particular, a spin cycle may be applied after the wash cycle and/or after the rinse cycle to wring wash fluid from the articles being washed. During a spin cycle, wash basket 120 is rotated at relatively high speeds. After articles disposed in wash basket 120 are cleaned and/or washed, the user can remove the articles from wash basket 120, e.g., by reaching into wash basket 120 through opening 105.

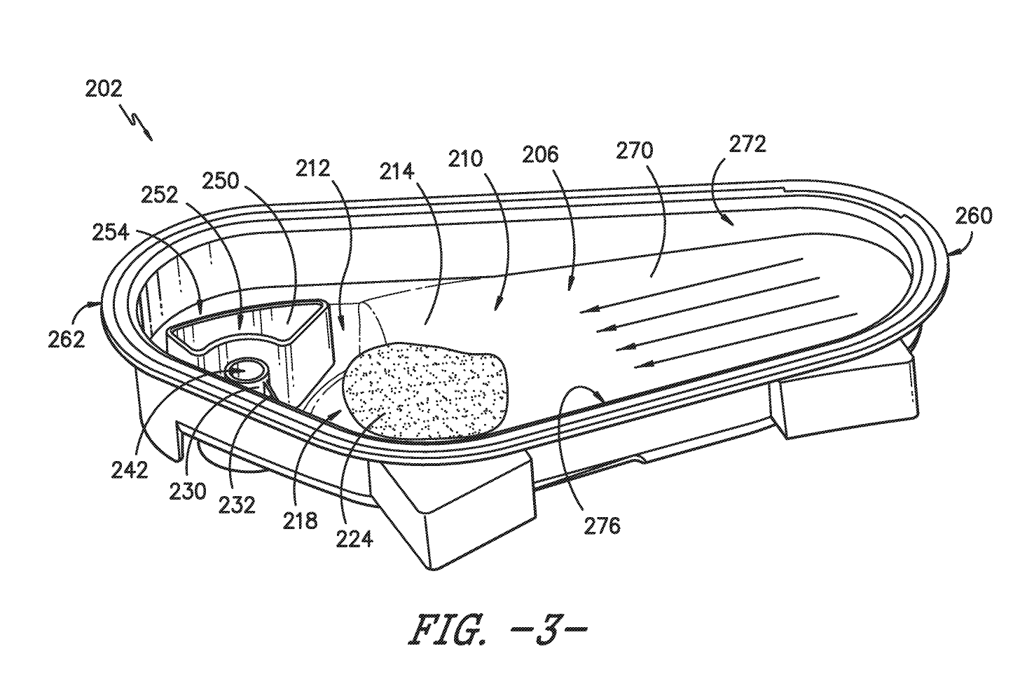

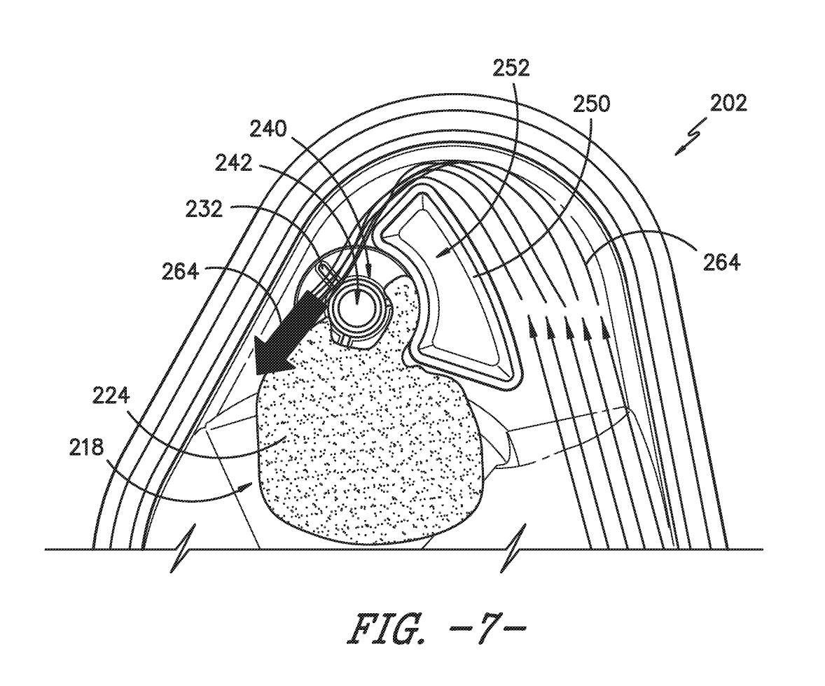

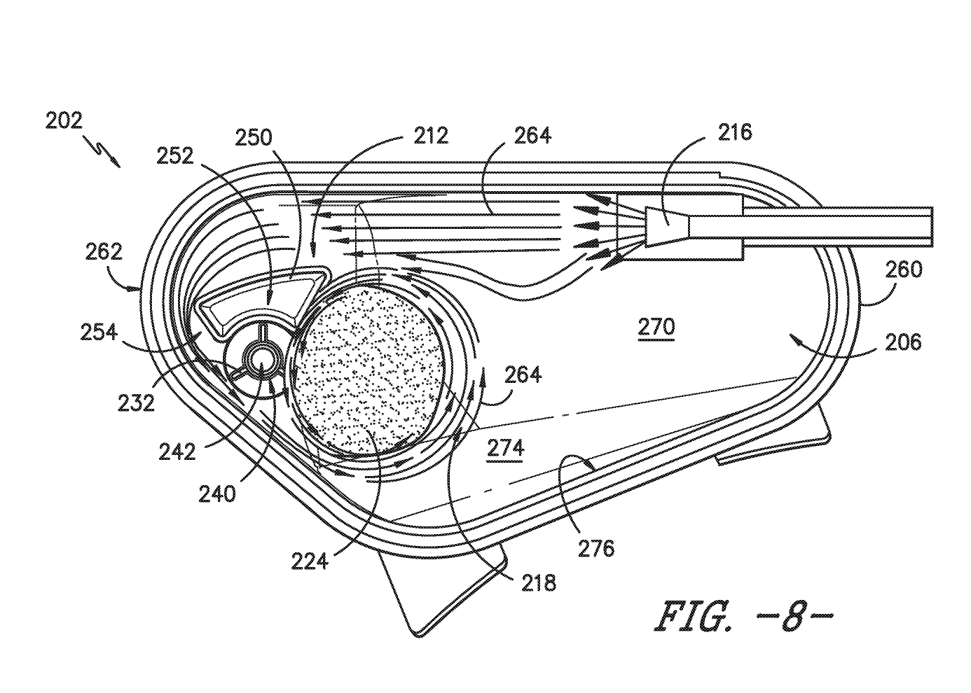

Referring now generally to FIGS. 3 through 8, additive dispenser 200 that may be used with washing machine appliance 100 will be described in more detail. Although the discussion below refers to additive dispenser 200, one skilled in the art will appreciate that the features and configurations described may be used for other additive dispensers in other washing machine appliances as well. For example, additive dispenser 200 may be positioned elsewhere within cabinet 102, may have a different shape or chamber configuration, and may dispense water, detergent, or other additives. Other variations and modifications of the exemplary embodiment described below are possible, and such variations are contemplated as within the scope of the present subject matter.

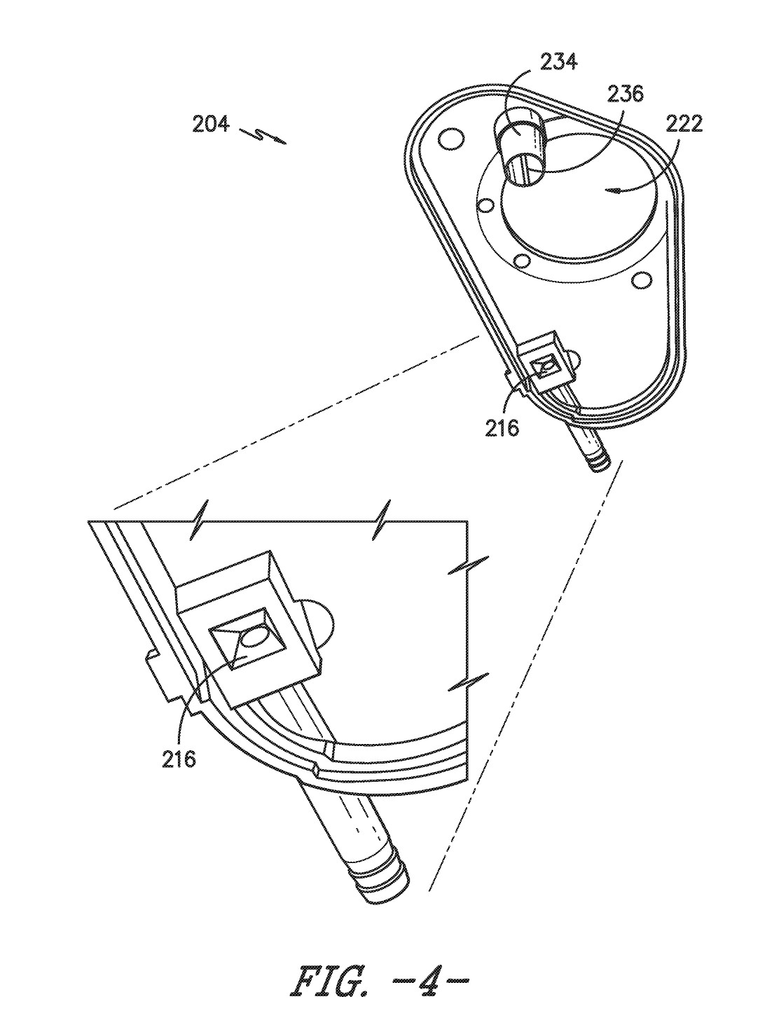

Additive dispenser 200 includes a lower portion 202 (FIG. 3) and an upper portion 204 (FIG. 4) that are spaced apart along the vertical direction V and joined together to form a dispenser chamber 206. Lower portion 202, upper portion 204, and other components of additive dispenser 200 may be made from any suitably rigid material. For example, according to the exemplary embodiment, lower portion 202 and upper portion 204 may be formed of injection molded plastic. In this regard, they may be injection molded from plastic such as HIPS (high impact polystyrene-injection molding grade) or ABS (injection molding grade).

According to the illustrated exemplary embodiment, lower portion 202 includes a bottom surface 210 defining a siphon sump area 212 and a plateau 214, which will be described in more detail below. Upper portion 204 may have substantially the same cross-sectional shape as lower portion 202 and may be fixed onto lower portion 202 using suitable mechanical fasteners, such as screws, bolts, rivets, etc. Similarly, glue, snap-fit mechanisms, interference-fit mechanisms, or any suitable combination thereof may secure lower portion 202 and upper portion 204.

Additive dispenser 200 may further include a water supply nozzle 216 for directing water into dispenser chamber 206. For example, as best illustrated in FIGS. 4 through 6, water supply nozzle 216 is mounted to upper portion 204 and is configured to provide a flow of water to dispenser chamber 206. In general, this water may be mixed with wash additive, such as powdered detergent 224, to form a wash liquid to be dispensed into the wash tub 121 from additive dispenser 200.

To supply water to water supply nozzle 216, washing machine appliance 100 may further include a plurality of valves (not shown) that supply hot and/or cold water to water supply nozzle 216 from a hot water supply and a cold water supply. Each valve may be, for example, a solenoid valve that is electrically connected to controller 108. However, any other suitable water valve may be used to control the flow of water. The hot and cold water may be diverted directly to water supply nozzle 216 or may be mixed to achieve the appropriate water temperature prior to delivery through water supply nozzle 216 into dispenser chamber 206. Other methods of water delivery into dispenser chamber 206 are possible and within the scope of the present invention.

Although the illustrated embodiment shows a single water supply nozzle 216 mounted to upper portion 204, it will be understood that different nozzle configurations may be used in alternative exemplary embodiments. For example, a water supply nozzle may be positioned on lower portion 202 of additive dispenser 200 or multiple nozzles may be placed throughout dispenser chamber 206. Other configurations are also possible and within the scope of the present subject matter.

Referring now specifically to FIGS. 3 through 8, plateau 214 is generally a sloping surface that may have one or more angles, each angle being configured to direct liquid toward the siphon sump 212. Plateau 214 is positioned vertically above the siphon sump 212 and may define a receiving surface 218. Upper portion 204 may define an opening 222 configured to receive a wash additive (e.g., powdered detergent 224). According to the illustrated embodiment, opening 222 is positioned directly over receiving surface 218.

Additive dispenser 200 may be mounted underneath top panel 140 of cabinet 102 (FIG. 2) such that opening 222 may receive wash additive poured into first aperture 150 or second aperture 152. For example, according to the example embodiment, first aperture 150 may coincide with opening 222, such that powdered detergent poured into first aperture 150 is received directly through opening 222. In this regard, the user may see bottom surface 210 of lower portion 202, and may thereby know how much detergent has been added to additive dispenser 200. However, one skilled in the art will appreciate that the present subject matter is not limited to such a method of adding wash additive to additive dispenser 200. For example, wash additive may be supplied directly from an additive reservoir located within cabinet 102 or apertures 150, 152 may connect to additive dispenser 200 indirectly, e.g., via a chute or channel.

Additive dispenser 200 may be mounted to top panel 140 using a plurality of mounting features, using mechanical fasteners, or in any other suitable manner. Similarly, glue, snap-fit mechanisms, interference-fit mechanisms, or any suitable combination thereof may secure additive dispenser 200 to cabinet 102. In addition, additive dispenser 200 may be easily removable, e.g., for periodic cleaning. One skilled in the art will appreciate that additive dispenser 200 may be mounted in other locations and use other mounting means according to alternative exemplary embodiments.

As described above, opening 222 is configured to receive wash additive through first aperture 150 of washing machine appliance 100 (i.e., a vertical-axis washing machine). However, one skilled in the art will appreciate that different configurations of additive dispenser 200 are possible in alternative washing machine appliances and according to alternative exemplary embodiments. For example, according to an alternative embodiment, additive dispenser 200 may be slidably received within the cabinet of a horizontal-axis washing machine, such that a user may pull additive dispenser 200 along the transverse direction T to slide it out of the cabinet. The user may then add wash additive through opening 222 before sliding additive dispenser 200 back into the cabinet prior to starting a wash cycle. Alternatively, additive dispenser 200 may draw wash additives from a separate storage container within washing machine appliance 100. Other configurations of additive dispenser 200 and dispenser chamber 206 are also possible and within the scope of the present subject matter. In addition, although only one dispenser chamber 206 is described herein, one skilled in the art will appreciate that more than one dispenser chamber may be included in alternative additive dispensers.

Referring again to FIGS. 3 through 8, bottom surface 210 may further define an inner siphon cylinder 230 that extends in a substantially vertical direction from siphon sump 212. One or more alignment ribs 232 may extend radially outward from inner siphon cylinder 230. Upper portion 204 may define an outer siphon cylinder 234 that extends downward over inner siphon cylinder 230 when upper portion 204 is mounted on lower portion 202. Outer siphon cylinder 234 may define a plurality of alignment slots 236 (FIG. 4) configured to receive alignment ribs 232. In this manner, inner siphon cylinder 230 and outer siphon cylinder 234 define a siphon 238.

Outer siphon cylinder 234 extends below plateau 214 very close to siphon sump 212. A siphon inlet 240 is therefore formed between inner siphon cylinder 230 and outer siphon cylinder 234 proximate to the siphon sump 212. In this manner, siphon 238 includes a siphon path that extends from siphon inlet 240, through an annular siphon channel defined between siphon cylinders 230, 234, and out a siphon outlet 242, such that wash liquid may flow through the inside of inner siphon cylinder 230 and into wash tub 121. According to the exemplary embodiment, the annular siphon channel has a uniform thickness defined between the outer surface of the inner siphon cylinder 230 and the inner surface of the outer siphon cylinder 234.

After detergent 224 is added to receiving surface 218, water may be added to create a wash liquid, and the siphon 238 is used to draw the wash liquid out of the dispenser chamber 206 and into wash tub 121. More particularly, to operate siphon 238 according to an example embodiment, controller 108 may cause water to enter dispenser chamber 206 through water supply nozzle 216 to raise the level of wash liquid in dispenser chamber 206. Eventually, the wash liquid rises above siphon outlet 242, which creates a siphon effect to draw wash liquid out of dispenser chamber 206 and into wash tub 121 through inner siphon cylinder 230. As long as nothing clogs siphon inlet 240, wash liquid may siphoned out of dispenser chamber 206 until the level of wash liquid drops below plateau 214 and siphon inlet 240.

Bottom surface 210 may further define an overflow weir 250 that extends vertically upward from siphon sump 212. A weir inlet 252 is defined at the top of overflow weir 250 and is in fluid communication with wash tub 121. Weir inlet 252 is typically positioned vertically above the top of inner siphon cylinder 230—i.e., the siphon outlet 242. In this manner, wash liquid is dispensed into wash tub 121 through overflow weir 250 only when the level of wash liquid is above weir inlet 252. When wash liquid is below this level, wash liquid is dispensed into wash tub 121 through the siphon 238, as described above. Notably, weir inlet 252 has a larger cross-section than siphon outlet 242 to allow for higher flow rates of wash liquid when dispenser chamber 206 is filled.

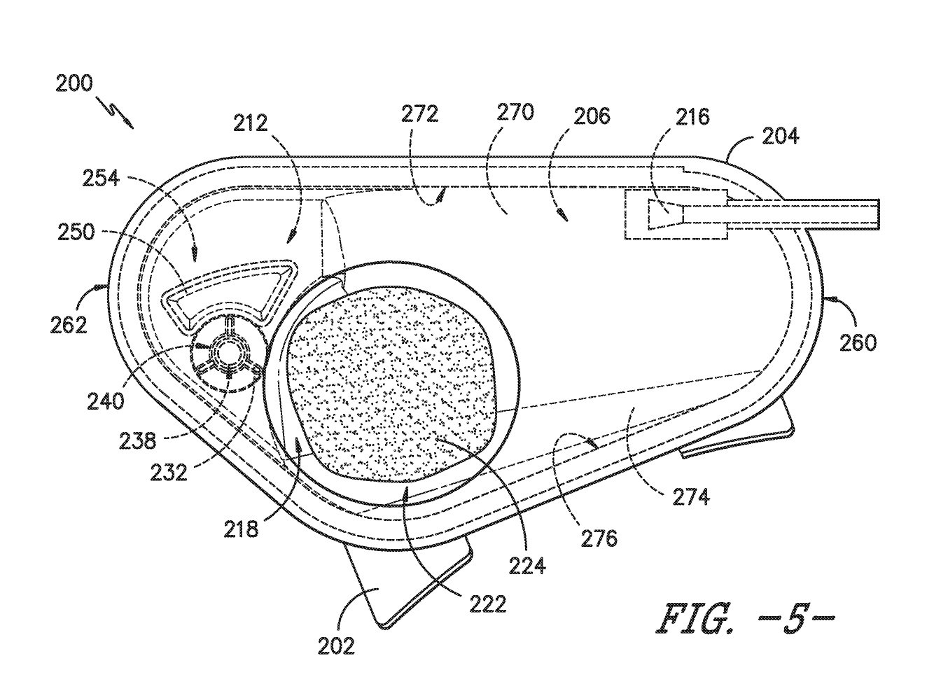

As best shown in FIG. 5, overflow weir 250 is positioned adjacent siphon 238 within the siphon sump 212. In addition, overflow weir 250 has a generally arcuate shape and wraps at least partly around siphon 238. In this manner, overflow weir 250, lower portion 202, and upper portion 204 define a flow channel 254 on the opposite side of overflow weir 250 from siphon 238. As described in detail below, this configuration directs the flow of water such that clogs in the siphon inlet 240 are reduced or eliminated.

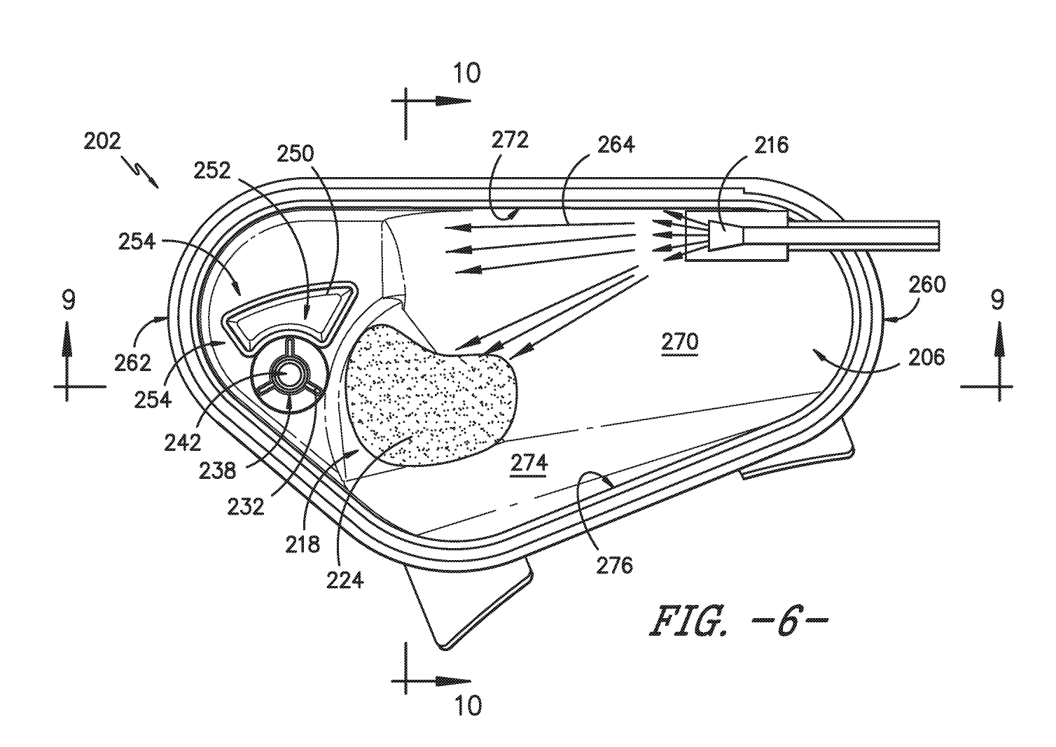

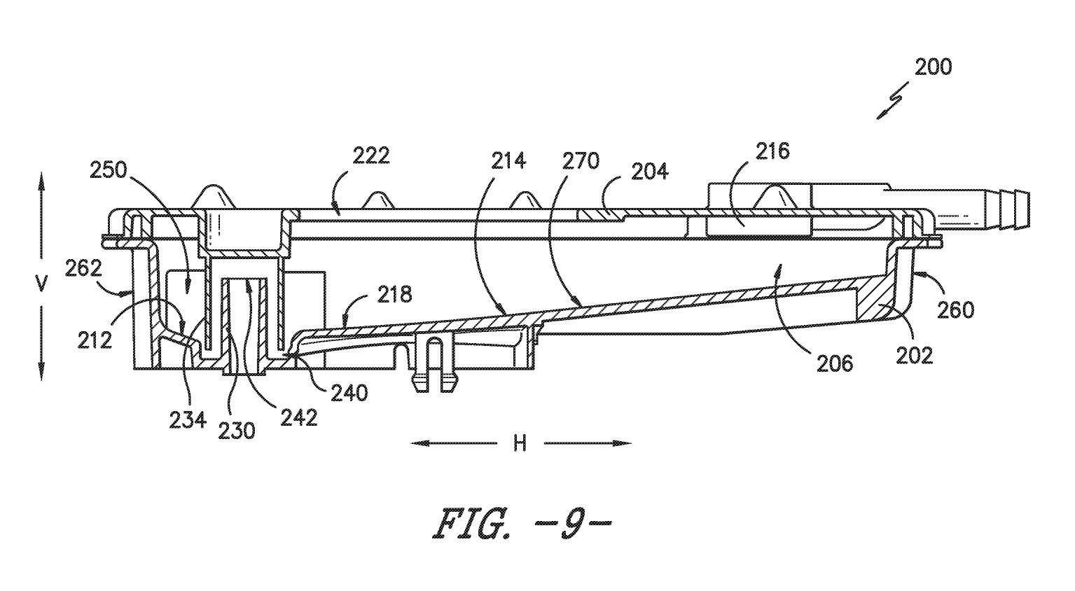

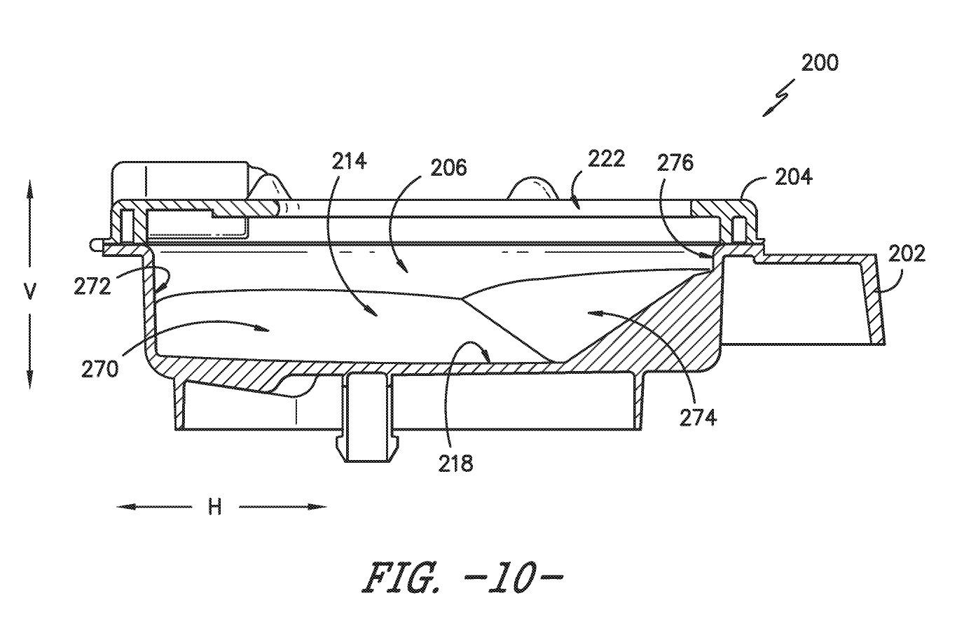

During operation of washing machine appliance 100, a user may add powdered detergent through first aperture 150. First aperture 150 coincides with opening 222, which is positioned directly over receiving surface 218. Therefore, powdered detergent is collected on receiving surface 218 of plateau 214. Notably, receiving surface 218 is positioned remote from siphon inlet 240. For example, as shown in FIGS. 6, 9, and 10, receiving surface 218 does not coincide with siphon inlet 240. Instead, receiving surface 218 may be adjacent to siphon inlet 240, and is sufficiently spaced apart to prevent detergent 224 from collecting in siphon inlet 240. More specifically, receiving surface 218 may be spaced at least 5 millimeters away from outer siphon cylinder 234 along a horizontal direction H (FIGS. 9 and 10).

In addition, receiving surface 218 has a lower angle relative to horizontal than the remainder of plateau 214. The angle of receiving surface 218 may be such that powdered detergent remains on receiving surface 218 until a flow of water entrains the powdered detergent. For example, receiving surface 218 may have an angle of less than five degrees relative to horizontal H (FIGS. 9 and 10). In this manner, powdered detergent has a reduced tendency of collecting around and clogging siphon inlet 240.

Referring now specifically to FIGS. 6 through 8, the flow path of water within dispenser chamber 206 will be described. Additive dispenser 200 and dispenser chamber 206 may generally define a first end 260 proximate water supply nozzle 216 and a second end 262 proximate siphon sump 212. According to the exemplary embodiment, water supply nozzle 216 directs a flow of water 264 (as indicated by arrows in FIGS. 6 through 8) in a substantially horizontal direction from first end 260 toward second end 262. In this manner, liquid dispensed onto plateau 214 always tends to flow toward siphon sump 212, and more particularly, to siphon inlet 240.

The flow of water 264 may be generally directed so as to slowly disperse and entrain powdered detergent. For example, as shown in FIGS. 6 through 8, the flow of water 264 may be directed primarily down a side of dispenser chamber 206, through flow channel 254. Notably, second end 262 is curved such that channel 254 wraps around overflow weir 250 and directs water directly past siphon inlet 240. As the flow of water 264 is directed past siphon inlet 240, it forces powdered detergent away from siphon inlet 240, thereby reducing the tendency of powdered detergent to clog the siphon inlet 240. More specifically, the flow of water 264 is directed past siphon 238 and back up onto plateau 214.

As best shown in FIGS. 9 and 10, plateau 214 has two sloping portions and receiving surface 218. A first sloping portion 270 is positioned underneath water supply nozzle 216 and slopes substantially in a direction toward siphon sump 212. More particularly, the flow of water 264 on first sloping portion 270 is substantially parallel with a first sidewall 272 of lower portion 202. A second sloping portion 274 is sloped substantially toward receiving surface 218 and toward siphon sump 212. More particularly, second sloping portion 274 is angled in a direction substantially away from a second sidewall 276 and toward siphon sump 212. Due to the geometry of bottom surface 210, sidewalls, 272, 276, and plateau 214, the flow of water 264 tends to circulate about receiving surface 218. In this manner, the powdered detergent deposited on top of receiving surface 218 is slowly eroded, entrained, and dispersed in the flow of water 264. By directing water adjacent to and past receiving surface 218, the tendency of powdered detergent to clog siphon inlet 240 may be reduced or eliminated when compared to designs that simply flush detergent using a shower of water or more direct flows of water.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A washing machine appliance defining a vertical, a lateral, and a transverse direction, the washing machine appliance comprising:
a cabinet;
a tub positioned within the cabinet;
a wash basket rotatably mounted within the tub, the wash basket defining a wash chamber for receiving articles for washing; and
an additive dispenser positioned within the cabinet and configured to provide wash liquid to the tub, the additive dispenser comprising:
a lower portion including a bottom surface defining a siphon sump and a plateau that includes a receiving surface, the siphon sump positioned below the plateau;
an upper portion joined with the lower portion to form a dispenser chamber, the upper portion defining an opening configured to receive a wash additive, the opening being positioned directly over the receiving surface;
a siphon having a siphon inlet positioned in the siphon sump; and
a water delivery nozzle mounted to the upper portion and configured to provide a flow of water to the dispenser chamber, the flow of water being directed adjacent to and past the receiving surface toward the siphon sump.

2. The washing machine appliance of claim 1, wherein the receiving surface is positioned remote from the siphon inlet.

3. The washing machine appliance of claim 1, wherein the receiving surface is oriented at an angle closer to horizontal than the rest of the plateau.

4. The washing machine appliance of claim 1, wherein the water delivery nozzle directs the flow of water in a substantially horizontal direction.

5. The washing machine appliance of claim 1, wherein the bottom surface defines an overflow weir positioned adjacent the siphon, and wherein the flow of water is directed around the overflow weir on a side opposite the siphon.

6. The washing machine appliance of claim 5, wherein the dispenser chamber has a first end proximate to the water delivery nozzle and a second end proximate the siphon sump, the second end of the dispenser chamber being curved to direct the flow of water past the siphon inlet and back up onto the plateau.

7. The washing machine appliance of claim 6, wherein the second end of the dispenser chamber and overflow weir define a flow channel which directs a substantial portion of the flow of water adjacent to and past the siphon inlet.

8. The washing machine appliance of claim 7, wherein the plateau is oriented at a larger angle relative to horizontal than the receiving surface, the plateau being configured to direct the flow of water toward the receiving surface and the siphon sump to create a circulating flow around the receiving surface.

9. The washing machine appliance of claim 1, wherein the wash additive is a powdered detergent, and wherein the receiving surface is oriented at an angle such that the powdered detergent remains on the receiving surface until the flow of water entrains the powdered detergent.

10. The washing machine appliance of claim 1, wherein the washing machine appliance is a vertical axis washing machine appliance.

11. An additive dispenser for providing wash liquid to a tub of a washing machine appliance, the additive dispenser comprising:
a lower portion including a bottom surface defining an overflow weir, a plateau that includes a receiving surface, and a siphon sump, the siphon sump positioned below the plateau;
an upper portion joined with the lower portion to form a dispenser chamber, the upper portion defining an opening configured to receive a wash additive, the opening being positioned directly over the receiving surface;
a siphon having a siphon inlet positioned in the siphon sump adjacent the overflow weir; and
a water delivery nozzle mounted to the upper portion and configured to provide a flow of water to the dispenser chamber, the flow of water being directed around the overflow weir on a side opposite the siphon.

12. The additive dispenser of claim 11, wherein the receiving surface is positioned remote from siphon inlet.

13. The additive dispenser of claim 11, wherein the receiving surface is oriented at an angle closer to horizontal than the rest of the plateau.

14. The additive dispenser of claim 11, wherein the water delivery nozzle directs the flow of water in a substantially horizontal direction.

15. The additive dispenser of claim 11, wherein the dispenser chamber has a first end proximate to the water delivery nozzle and a second end proximate the siphon sump, the second end of the dispenser chamber being curved to direct the flow of water past the siphon inlet and back up onto the plateau.

16. The additive dispenser of claim 15, wherein the second end of the dispenser chamber and overflow weir define a flow channel which directs a substantial portion of the flow of water adjacent to and past the siphon inlet.

17. The additive dispenser of claim 16, wherein the plateau is oriented at a larger angle relative to horizontal than the receiving surface, the plateau being configured to direct the flow of water toward the receiving surface and the siphon sump to create a circulating flow around the receiving surface.

18. The additive dispenser of claim 11, wherein the wash additive is a powdered detergent, and wherein the receiving surface is oriented at an angle such that the powdered detergent remains on the receiving surface until the flow of water entrains the powdered detergent.

19. A washing machine appliance defining a vertical, a lateral, and a transverse direction, the washing machine appliance comprising:
a cabinet;
a tub positioned within the cabinet;
a wash basket rotatably mounted within the tub, the wash basket defining a wash chamber for receiving articles for washing; and
an additive dispenser positioned within the cabinet and configured to provide wash liquid to the tub, the additive dispenser comprising:
a lower portion and an upper portion joined with the lower portion to form a dispenser chamber;
a water delivery nozzle mounted to the upper portion proximate a first end of the dispenser chamber, the water delivery nozzle being configured to provide a flow of water to the dispenser chamber;
a siphon sump proximate a second end of the dispenser chamber and including a siphon and a siphon inlet; and
a sloping surface defining a receiving surface, the siphon sump positioned below the sloping surface,
wherein the flow of water is directed from the first end toward the second end directly toward the siphon sump, such that the flow of water passes adjacent to the receiving surface, and wherein the second end of the dispenser chamber is curved to direct the flow of water past the siphon inlet and back up onto the sloping surface.

20. The washing machine appliance of claim 19, wherein the upper portion defines an opening configured to receive a wash additive, the opening being positioned directly over the receiving surface, and wherein the sloping surface is oriented at a larger angle relative to horizontal than the receiving surface, the sloping surface configured to direct the flow of water toward the receiving surface and the siphon sump to create a circulating flow around the receiving surface.
